(19) United States
(12) Patent Application Publication
(10) Pub. No.: US 2009/0252392 A1
(43) Pub. Date: Oct. 8, 2009

(54) System and method for analyzing medical images

(75) Inventor: Martin Panarace, Buenos Aires (AR)

Correspondence Address: MCDERMOTT WILL & EMERY LLP, 600 13TH STREET, N.W., WASHINGTON, DC, 20005-3096, US

(73) Assignee: GOYAIKE S.A.A.C.I.Y.F

(21) Appl. No.: 12/078,890

(22) Filed: Apr. 8, 2008

(51) Int. Cl. G06K 9/00

(52) U.S. Cl. 382/131; 382/128; 382/168

(57) ABSTRACT

A system and method are provided for analyzing medical images and monitoring pregnancies for a plurality of animal patients. Medical images obtained from medical imaging devices are scanned, and extracted data are stored in a database. A color histogram is generating characterizing the image based on placental blood flow.

### FIELD OF THE INVENTION

This application relates generally to systems and methods for analyzing medical images, and more specifically to systems and methods for processing and analyzing medical images to detect pregnancy abnormalities.

### BACKGROUND

Biotechnological techniques, such as nuclear transfer and cloning, have become popular areas of research and development. However, these processes have shown low efficiency, mainly due to a high mortality rate of embryos and fetuses during pregnancy. To date, the causes of the mortalities have not yet been completely diagnosed until after they have occurred, or after signs of abortion present. Medical imaging technology, such as ultrasound and Doppler have been used to monitor human patients during pregnancy. However, in veterinary medicine, not much data is available using these techniques, and reliable ultrasound markers of pregnancies at risk of loss have not previously been realized.

Even if parameters could be determined which indicated at risk pregnancy using medical imaging techniques, using these reproductive technologies in livestock animals research would result in voluminous amounts of data. In order to be useful, the data would need to be processed and readily searchable.

### SUMMARY OF THE INVENTION

Accordingly, a system and method are provided for analyzing and processing medical images of animal patients during pregnancy. The system and method enable the monitoring of pregnancies throughout gestation for possible abnormalities.

A system for analyzing medical images from a plurality of animal species used in monitoring pregnancies is provided. The system may include one or more medical image apparatus for obtaining medical images of a patient, a processor for receiving and analyzing the images, and a database for storing the images and the data extracted from the image. The processing unit may include a data retrieval module for extracting data from the image, the data including one or more technical settings associated with the medical imaging device from which the image was obtained, and an analysis module for providing a plurality of tools for analyzing the images and the extracted data.

A computer-implemented medical imaging analysis apparatus is provided. The medical imaging apparatus may include a data retrieval module for retrieving medical images from one or more medical imaging devices and extracting data from the retrieved medical images, a histogram module for generating a color histogram representing one or more monitoring parameters based on the retrieved images and data, a search module for providing a graphical user interface enabling a user to retrieve the store medical images and image data, and a reporting module for outputting one or more reports representing the medical images and data.

Additionally, a method of analyzing medical images from a plurality of animal species used in monitoring pregnancies is provided. The method comprises retrieving one or more medical images from a medical imaging device, extracting data from the medical images for each medical images, and storing the image and the extracted data. The extracted data may include one or more technical settings associated with the medical imaging device. The steps of retrieving, extracting, and storing may be repeated at predetermined time intervals to detect changes in the pregnancy.

### BRIEF DESCRIPTION OF THE DRAWINGS

FIG. 1 depicts a system for analyzing medical images, in accordance with some embodiments.

FIG. 2 depicts a processing unit for processing medical images, in accordance with some embodiments.

FIG. 3 depicts an analysis module for analyzing medical images, in accordance with some embodiments.

FIG. 4 is a flowchart depicting a method of retrieving and analyzing medical images, in accordance with some embodiments.

### DETAILED DESCRIPTION

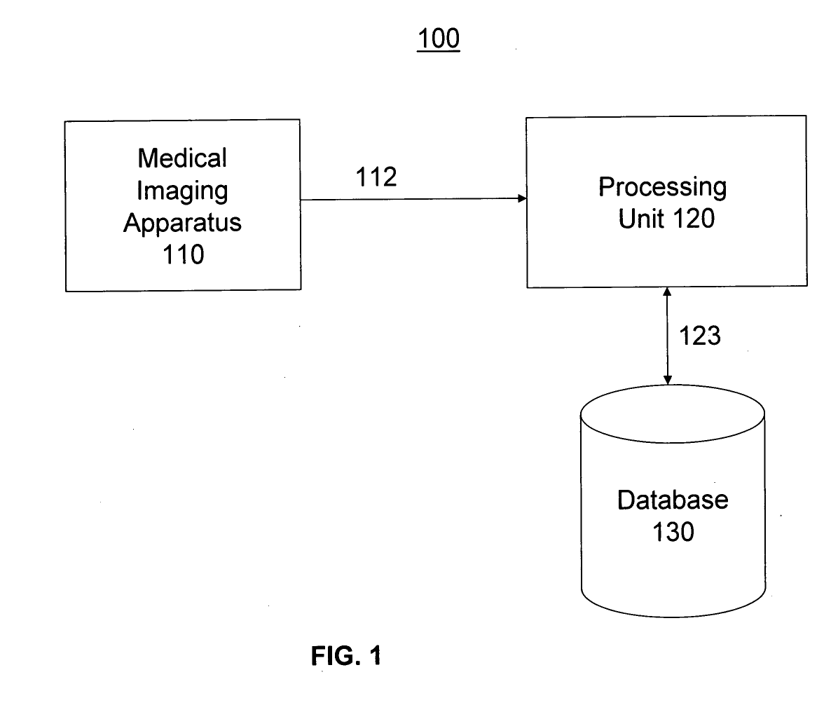

FIG. 1 depicts an overall configuration of a system 100 for analyzing medical images. System 100 may include one or more medical imaging apparatus 110, a processing unit 120, and a database 130. Medical imaging apparatus 110 may be communicatively coupled to processing unit 120 via communication link 112. Likewise, processing unit 120 may be communicatively coupled to database 130 via communication link 123. While depicted as separate entities, processing unit 120 and database 130 may both be components of a single computer workstation, such as, for example, a server.

Medical imaging apparatus 110 may include apparatus such as echo-doppler and/or ultrasound imaging machines. These apparatus are known to capture digital images in human patients which contain information that may be used to diagnose patient conditions and to monitor pregnancies. The inventors have determined several factors that may be used to monitor pregnancies in animal patients. Parameters may include, for example, placental blood flow, crown rump length, biparietal diameter, abdominal circumference, umbilical cord insertion size, amniotic sac mean diameter, vascular resistance index of the umbilical cord, heart rate, uterine arteries measurements, venous ductus measurements, and/or other parameters.

Processing unit 120 may be configured to retrieve the images captured by medical imaging apparatus 110, and to store the images in database 130. Processing unit 120 may be further configured to parse the retrieved images to obtain predefined data, which may be stored separately from the image. Thus, database 130 may be configured to store the retrieved images and the abstracted data.

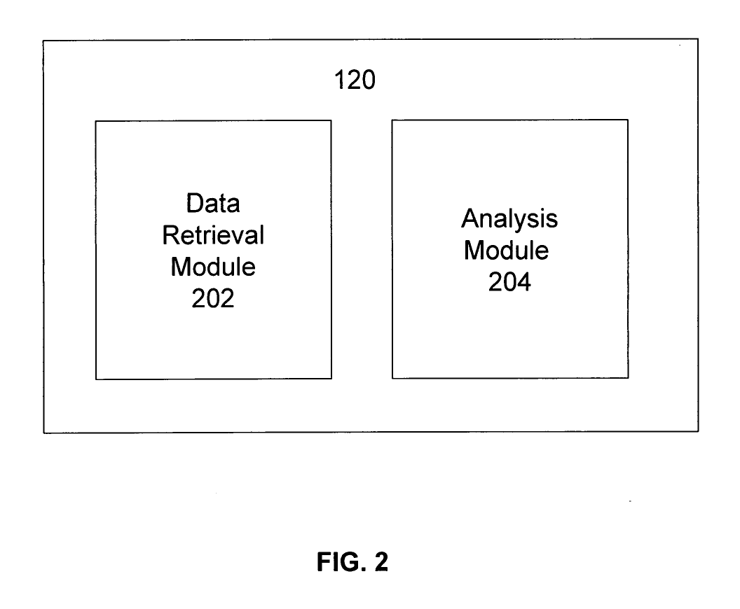

Processing unit 120 is depicted in greater detail in FIG. 2. Processing unit 120 may include a data retrieval module 202 and an analysis module 204. Data retrieval module 202 may be configured to facilitate the process of obtaining data from the medical images. According to some embodiments, data retrieval module 202 may be configured to define templates for obtaining data from the medical images. The template defines the area in which the desired data appears in the medical image. The desired data may include, for example, patient identification information, technical settings of the equipment used to obtain the image, alpha-numeric data representing one or more parameters, and/or other data. One or more templates may be generated. For example, different templates may be generated for different machine types, patient types, etc.

Before processing an image, the appropriate template may be selected. Optical character recognition (OCR) or other known data retrieval techniques may then be used to extract the data based on the selected template.

Data retrieval module 202 may also be configured to capture and store the retrieved data. According to one embodiment, data may be organized by patient number, allowing data for one patient to be collected throughout the pregnancy period in one file. Data may also be organized based on any other retrieved data. Data retrieval module 202 may also be configured to format the retrieved data for storage in the database.

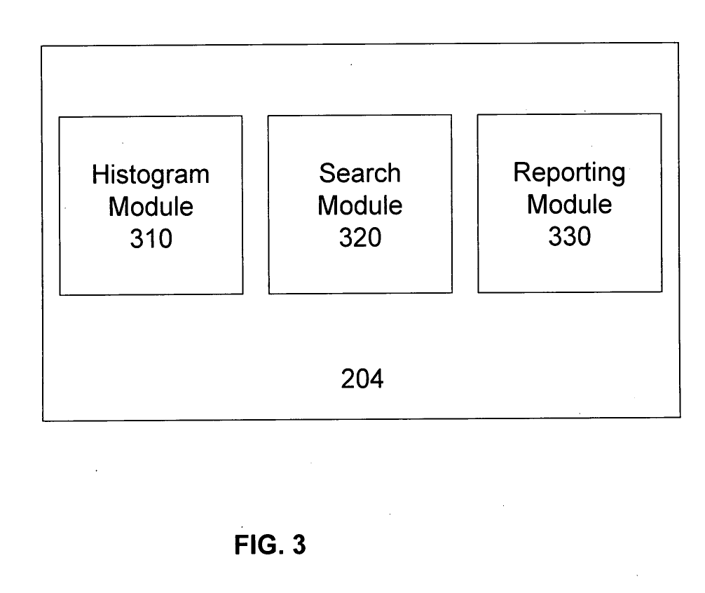

Analysis module 204 may include a plurality of sub-modules. For example, as depicted in FIG. 3, analysis module 204 may include histogram module 310, search module 320, and reporting module 330.

In accordance with one embodiment, color histograms may be generated using the data obtained from the medical images. The color histograms may be used to provide a graphical representation of one or more parameters used to monitor pregnancies. For example, histogram module 310 may be configured to generate color histograms representing placental blood flow. The histograms may depict data for one patient, a species of animal patients, or multiple species. In some embodiments, the histogram may be used to chart one patient's data through pregnancy. In other embodiments, data may be represented in the aggregate for multiple patients of one or more species.

Histogram module 310 may be configured to allow a users to select an area of interest from a medical image. For example, the user may select the area of interest by pointing a selection device, such as a mouse, to a particular area and dragging to select a complete area. The selected area may be highlighted, enabling the user to confirm the selection. Placental blood flow may be depicted in the medical image in a range of colors, indicating differing conditions. The colors may be representative of the type of blood flow. For example, portions with more yellow colors representing pixels containing more red cells and portions with more red or brown sections indicating pixels containing less red cells. Thus, the histogram enables the type of blood flow to be classified throughout a pregnancy.

A user interface may be provided enabling a user to select the number of colors to display. According to some embodiments, the number of colors may be based on the gestational age. In other embodiments, the number of colors may be based on the range of colors seen in the selected area. The histograms may be used to display placental blood flow amount and to calculate a vascular index, which is a ratio between a particular color and the total surface of a given placentome.

Search module 320 may be configured to provide a graphical user interface allowing the image and data files to be searched. The graphical user interface may provide a plurality of filter options for searching, such as, for example, searching by date, patient number, species, medical imaging device type, and/or other search options.

Reporting module 330 provides a graphical user interface for generating one or more reports. The graphical user interface enables a user to select items to be included in a report. For example, a report may be generated representing the medical history of one patient throughout a pregnancy. Thus, the report may include images taken at different times during the pregnancy, one or more histograms, charts providing numerical parameter data, and/or other patient information.

Reports may also be generated which include data from a plurality of patients of the same species. This enables a user to easily compare results which are useful in determining specific time periods or conditions which may lead to miscarriage. Similarly, reports may be generated representing more than one species.

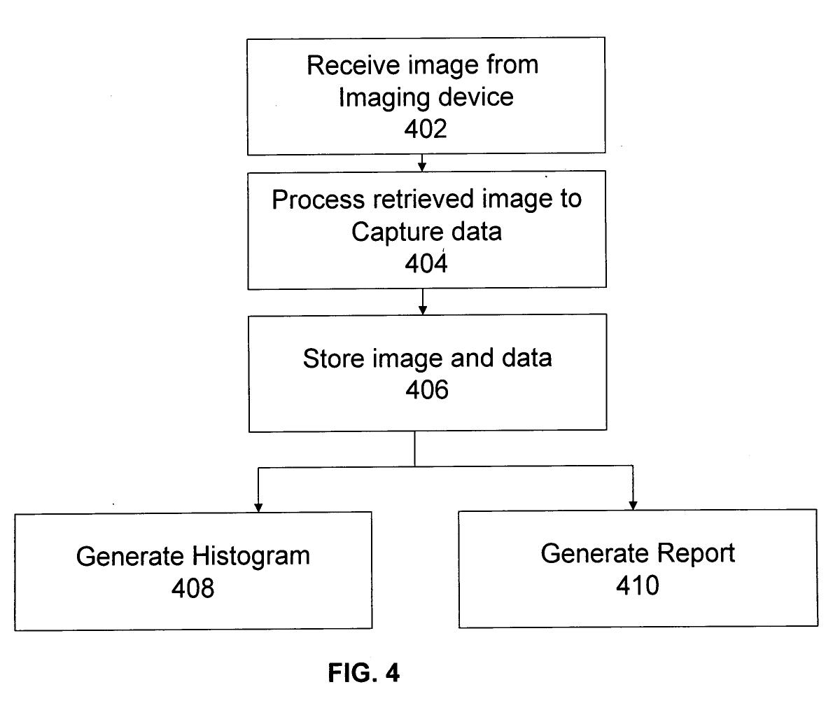

FIG. 4 is a flowchart depicting a method of analyzing medical images in accordance with various embodiments. As depicted at 402, the method begins when an image is received from a medical imaging device. The image may be an echo-doppler, sonogram, ultrasound, or other medical image of a pregnant animal patient.

The received image may be processed, as depicted at 404, to obtain data embedded therein. Processing may include obtaining data which indicates a name or other patient identification, the type of machine used to capture the image, the date the image was taken, measurement date, and/or other data. As described above, a template may be selected which indicates the location of data within the image.

As depicted at 406, the retrieved images and data are stored. According to some embodiments, data and images may be stored based on patient identification information retrieved from the image. For example, the data may be arranged hierarchically under a patient identified.

Several options may be presented for analyzing the stored data and images. As depicted at 408, a color histogram representing measured data for one or more patients may be generated. To generate the histogram, a user may select an image from the database and elect an area of interest from the image. A color histogram may then be generated depicting the varying conditions within the selected area. Alternatively or additionally, one or more reports may be generated at 410 which characterized the retrieved data for one or more patients.

The methods described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims.

What is claimed is:

1. A method of analyzing medical images from a plurality of animal species used in monitoring pregnancies, the method comprising:
retrieving one or more medical images from a medical imaging device;
for each medical image, extracting data from the medical image, the data including one or more technical settings associated with the medical imaging device; and
storing the image and the extracted data,
wherein the steps of retrieving, extracting, and storing are repeated at predetermined time intervals to detect changes.

2. The method of claim 1, wherein extracting data further comprises:
defining a template representative of the data located in the image; and
performing an optical scanning operation on the image to obtain the data based on the defined template.

3. The method of claim 1, further comprising:
generating a color histogram, based on the one or more medical images, representing blood flow in the placenta.

4. The method of claim 1, further comprising:
generating a report based on the image and the extracted data.

5. The method of claim 4, wherein the report comprises data representing a plurality of images for a single patient.

6. The method of claim 4, wherein the report comprises data representing a plurality of images for different patients.

7. The method of claim 4, wherein the report comprises data representing a plurality of images for different patients of different species.

8. The method of claim 1, wherein the extracted data further comprises a patient identifier and one or more measured parameters.

9. The method of claim 8, wherein the measured parameters comprise one or more of crown rump length, biparietal diameter, femur, humerus, abdominal circumference, umbilical cord insertion size, amniotic sac mean diameter, placentome area, heart rate, vascular resistance index of the umbilical cord, uterine arteries measurements, and venous ductus measurements.

10. The method of claim 3, wherein generating a color histogram comprises:
receiving, as a first input, a selection of a desired area of a medical image;
receiving, as a second input, a selection of a desired number of colors to display in the histogram; and
outputting a color histogram of the selected area indicating the number of points in each selected color.

11. A system for analyzing medical images from a plurality of animal species used in monitoring pregnancies, the system comprising:
one or more medical image apparatus for obtaining medical images of a patient;
a processor for receiving and analyzing the images; and
a database for storing the image and data extracted from the image,
wherein the processing unit comprises:
a data retrieval module for extracting data from the image, the data including one or more technical settings associated with the medical imaging device from which the image was obtained; and
an analysis module for providing a plurality of tools for analyzing the image and the extracted data.

12. The system of claim 10, wherein the analysis module comprises a histogram generator configured to generate a color histogram, based on the one or more medical images, representing blood flow in the placenta.

13. The system of claim 10, wherein the analysis modules comprises a search engine which provides a graphical user interface enabling a user to retrieve stored images and image data.

14. A computer-implemented medical image analysis apparatus comprising:
a data retrieval module for retrieving medical images from one or more medical imaging devices and extracting data from the retrieved medical images;
a histogram module for generating a color histogram representing one or more monitoring parameters based on the retrieved images and data;
a search module for provides a graphical user interface enabling a user to retrieve the stored medical images and image data; and
a reporting module for outputting one or more reports representing the medical images.

15. The medical image analysis apparatus of claim 14, wherein the data retrieval module is configured to:
define a template representative of the data located in a retrieved medical image; and
perform an optical scanning operation on the retrieved medical image to obtain the data based on the defined template.

16. The medical image analysis apparatus of claim 14, wherein the histogram module is configured to:
determine an amount of different colors is a selected area of a medical image; and
generate a histogram mapping the different colors to points in the image.

17. The medical image analysis apparatus of claim 14, wherein the histogram module generates a color histogram representing placental blood flow.

18. The medical image analysis apparatus of claim 14, wherein the reports are output in one or more of a PDF file, a word processor file, and a spreadsheet.
